(19) United States
(12) Patent Application Publication
(10) Pub. No.: US 2026/0142499 A1
(43) Pub. Date: May 21, 2026

(54) WIRELESS POWER SUPPLY SYSTEM

(71) Applicants: Nobuyuki KURITA, maebashi-shi (JP); ADTEX Inc., Takasaki-shi (JP); Kake Educational Institution, Okayama-shi, Okayama (JP)

(72) Inventors: Nobuyuki KURITA, maebashi-shi (JP); Hiroo SATO, Takasaki-shi (JP); Hiroki ISHIDA, Okayama-shi (JP); Shinji KOSHINO, Takasaki-shi (JP); Toru TAKEDA, Takasaki-shi (JP); Hiroshi MUKAIYAMA, Takasaki-shi (JP); Eiji OGIWARA, Takasaki-shi (JP)

(21) Appl. No.: 19/449,407

(22) Filed: Jan. 15, 2026

Related U.S. Application Data
(63) Continuation of application No. PCT/JP2024/025587, filed on Jul. 17, 2024.

(30) Foreign Application Priority Data
Jul. 21, 2023 (JP) 2023-119457

(51) Int. Cl. H02J 50/12; H02J 50/90

(52) U.S. Cl. CPC H02J 50/12; H02J 50/90

(57) ABSTRACT

A wireless power supply system utilizing the PT symmetry including a power supply circuit provided with a power supply coil and a power receiving circuit provided with a power receiving coil, wherein each of the power supply circuit and power receiving circuit has a resonant circuit, and in the resonant circuit of the power receiving circuit, the power receiving coil and two capacitors are connected in series and a rectifier circuit is connected to both ends of one of the two capacitors.

### CROSS-REFERENCE TO RELATED APPLICATIONS

This application claims the benefit of priority and is a Continuation application of the prior International Patent Application No. PCT/JP2024/025587, with an international filing date of Jul. 17, 2024, which designated the United States, and is related to the Japanese Patent Application No. 2023-119457, filed Jul. 21, 2023, the entire disclosures of all applications are expressly incorporated by reference in their entirety herein.

### TECHNICAL FIELD

The present invention relates to a wireless power supply system utilizing Parity-Time symmetry (hereinafter referred to as “PT symmetry”).

### BACKGROUND OF THE INVENTION

Conventionally, several technologies for the contactless wireless power supply have been known, including an electromagnetic induction system and a magnetic field resonance system. Among these, an electromagnetic induction wireless power supply technology is used, for example, for charging mobile phones, where coils are arranged vertically. Namely, the electromagnetic induction wireless power supply technology functions as an electrical transformer itself, where electricity flows when a power supply coil and a power receiving coil are in close contact.

However, the electromagnetic induction wireless power supply technology cannot achieve a large distance between the power supply coil and the power receiving coil. If the positions of the power supply coil and the power receiving coil are misaligned or separated even slightly, neither charging nor power supply is possible. Therefore, there are problems that it is difficult to apply to artificial devices installed inside the human body such as an artificial heart and it is difficult to apply to devices with multi-directional rotation or axis misalignment such as a robot arm.

Furthermore, the magnetic field resonance wireless power supply technology is developed at a university in U.S. around 2006 to 2007. The distance between the power supply coil and the power receiving coil can be larger compared to the electromagnetic induction system. Thus, the magnetic field resonance wireless power supply technology is at a level close to practical application. However, the electricity cannot be transmitted unless the distance between the power supply coil and the power receiving coil is kept constant. The electricity cannot be transmitted if the distance decreases, the distance increases or the angles are different. Due to the above described sensitivity, it is also difficult to apply the magnetic field resonance wireless power supply technology to the artificial devices such as the artificial heart installed inside the human body or the devices with multi-directional rotation or axis misalignment such as the robot arm.

To solve the above described problems, for example, Patent Document 1 discloses a contactless power supply system using a magnetic field resonance that includes a control device having functions for adjusting a positional relationship and an angle between the power supply coil and the power receiving coil. Thus, the electric power can be stably supplied to the artificial heart and the like.

In addition, for example, Patent Document 2 discloses a technology for achieving rotation and bending by providing contactless power supply sections at two locations in a contactless power supply rotary module used in a robot to facilitate installation and addition of an arm in a multi-joint robot having a first arm and a second arm.

### PRIOR ART DOCUMENTS

### Patent Documents

Patent Document 1: International Patent Application Publication No. 2018/150678
Patent Document 2: Japanese Patent Application Publication No. 2020-196085
Patent Document 3: Japanese Patent Application Publication No. 2022-121324

### Non-Patent Documents

Non-patent Document 1: Sid Assawaworrarit, Xiaofang Yu & Shanhui Fan, “Robust wireless power transfer using a nonlinear parity-time-symmetric circuit”, Nature, 15 Jun. 2017, volume 546, p. 387-390
Non-patent Document 2: Xianglin Hao, Ke Yin, Jianlong Zou, Ruibin Wang, Yuangen Huang, Xikui Ma & Tianyu Dong, “Frequency-Stable Robust Wireless Power Transfer Based on High-Order Pseudo-Hermitian Physics”, Phys. Rev. Lett. 2023, 130, 077202
Non-patent Document 3: J. Zhou, B. Zhang, W. Xiao, D. Qiu, and Y. Chen, “Nonlinear parity-time-symmetric model for constant efficiency wireless power transfer: application to a drone-in-flight wireless charging platform”, IEEE Trans. Ind. Electron., August 2019, vol. 66, no. 5, pp. 4097-4107
Non-patent Document 4: H. Ishida, T. Kyoden, and H. Furukawa, “Application of parity-time symmetry to low-frequency wireless power transfer system”, IEEJ J. Ind. Appl., 2022, vol. 11, no. 1, pp. 59-68
Non-patent Document 5: Isao Takahashi, Kazuhiro Hori, “Improvement of Input Current Waveforms of a Single Phase Diode Rectifier by Passive Devices”, IEEJ Transactions on Industry Applications, 1997, 117 (1), pp. 13-18

### SUMMARY OF THE INVENTION

### Problem to be Solved by the Invention

However, the contactless power supply system using the magnetic field resonance shown in Patent Document 1 requires functions to adjust the distance between the power supply coil and the power receiving coil to be constant and to adjust the angle to be constant. This causes problems that a power transmission device becomes large-scale and advanced control such as adjusting the positional relationship and the angle between the coils must be continuously performed. Thus, a load is applied to the control unit of the power transmission device. In addition, there is also a problem that the advanced control function stops during battery replacement.

In the contactless power supply system for the robot arm as shown in Patent Document 2, there is a problem that the electric power cannot be supplied at certain rotation angles when the power supply coil rotates in conjunction with the rotation of the power supply target and the electric power is supplied or received to/from the rotating target. In addition, it is not possible for one arm to bend in any direction at the tip end and rotate 360 degrees in any direction. Thus, when 360-degree rotation in any direction is desired, the structure becomes complex with a multiple joint.

The present invention is made for solving the above described problems and aims for providing a wireless power supply system utilizing PT symmetry that requires no adjustment or control of the positions and the angle of the power supply coil and the power receiving coil, has a simple structure and can continuously supply the electric power wirelessly without interruption even if the positions and the angle of the power supply coil and the power receiving coil shift or separate slightly, with more tolerance than the conventional system regarding the positional relationship between the two coils.

### Means for Solving the Problem

In order to solve the above described problems, the present invention is a wireless power supply system utilizing Parity-Time symmetry (hereinafter referred to as “PT symmetry”), the wireless power supply system including: a power supply circuit provided with a power supply coil; and a power receiving circuit provided with a power receiving coil, wherein each of the power supply circuit and the power receiving circuit includes a resonant circuit, in the resonant circuit of the power receiving circuit, the power receiving coil and two capacitors are connected in series and a rectifier circuit is connected to both ends of one of the two capacitors for continuously performing a wireless power supply while preserving the PT symmetry and keeping a transmission power constant.

Alternatively, the present invention is a wireless power supply system utilizing Parity-Time symmetry (hereinafter referred to as “PT symmetry”), the wireless power supply system including: a power supply circuit provided with a power supply coil; and a power receiving circuit provided with a power receiving coil, wherein each of the power supply circuit and the power receiving circuit includes a resonant circuit, and in the resonant circuit of the power receiving circuit, a rectifier circuit is connected to the resonant circuit, a power factor correction circuit is provided between a rectifier diode and a smoothing capacitor in the rectifier circuit, and a power factor of the power factor correction circuit is adjusted to between 0.6 and 1.0 for continuously performing a wireless power supply while preserving the PT symmetry and keeping a transmission power constant.

Alternatively, the present invention is a wireless power supply system utilizing Parity-Time symmetry (hereinafter referred to as “PT symmetry”), the wireless power supply system including: a power supply circuit provided with a power supply coil; and a power receiving circuit provided with a power receiving coil, wherein each of the power supply circuit and the power receiving circuit includes a resonant circuit, in the resonant circuit of the power receiving circuit, a rectifier circuit is connected to the resonant circuit, a step-down chopper type DC/DC converter is provided downstream of the rectifier circuit, and a value of AC equivalent load resistance connected to the resonant circuit of the power receiving circuit is adjusted by a value of a duty ratio D of the DC/DC converter for continuously performing a wireless power supply while preserving the PT symmetry and keeping a transmission power constant.

### Effect of the Invention

According to the wireless power supply system of the present invention, in the wireless power supply utilizing the PT symmetry, no adjustment or control of the positions and the angle of the power supply coil and the power receiving coil is required, the structure is simple and high transmission efficiency can be maintained without interruption even if the positions and the angle of the power supply coil and the power receiving coil shift or separate slightly. Therefore, it becomes possible to continuously supply the electric power wirelessly with more tolerance than the conventional systems regarding the positional relationship between the two coils, with as few restrictions as possible.

### BRIEF DESCRIPTION OF DRAWINGS

FIGS. 1A and 1B are drawings showing the positional relationship between coils and the relationship between a rotation angle θ and a magnetic coupling coefficient kₘ when a rotation center O is at a central part of a power receiving coil in a rotating power supply target in a wireless power supply system utilizing PT symmetry.

FIGS. 2A and 2B are drawings showing the positional relationship between coils and the relationship between the rotation angle and the magnetic coupling coefficient kₘ when the rotation center O is at one of the two magnetic poles provided at both ends of a solenoid-type power receiving coil in a rotating power supply target in the wireless power supply system utilizing PT symmetry according to the embodiment 1 of the present invention.

FIGS. 3A and 3B are graphs showing a relationship between a rotation angle and a transmission power of two coils (power supply coil and power receiving coil) used in the wireless power supply system.

FIGS. 4A to 4C are explanatory drawings showing an example of a schematic configuration of the wireless power supply system.

FIG. 5 is a graph of an experimental result showing a relationship between a magnetic coupling coefficient kₘ, a critical magnetic coupling coefficient k_{mc} and a transmission power when rotating around the central part of the power receiving coil shown in FIG. 1A.

FIGS. 6A and 6B are conceptual diagrams showing the circuit configuration of a conventional magnetic resonance wireless power supply system utilizing PT symmetry.

FIG. 7 is a conceptual diagram showing an example of the circuit configuration of a magnetic resonance wireless power supply system utilizing PT symmetry according to the embodiment 1 of the present invention.

FIGS. 8A and 8B are conceptual diagrams showing another example of the circuit configuration of a magnetic resonance wireless power supply system utilizing PT symmetry according to the embodiment 1 of the present invention.

FIG. 9 is a circuit configuration diagram showing an example of a power receiving circuit in a magnetic resonance wireless power supply system utilizing PT symmetry according to the embodiment 2 of the present invention.

FIGS. 10A and 10B show simulation circuits for comparing and verifying the effect of a choke coil in the embodiment 2 of the present invention.

FIGS. 11A and 11B show the time-based changes (waveforms) of an input voltage Vi and an input current li for comparing and verifying the effect of a choke coil in the embodiment 2 of the present invention.

FIG. 12 is a circuit configuration diagram showing another example of a power receiving circuit in a magnetic resonance wireless power supply system utilizing PT symmetry according to the embodiment 2 of the present invention.

FIG. 13 is a table of an experimental result showing the relationship between a power factor and a coil rotation capability in the power receiving circuit shown in FIG. 12.

FIG. 14 is a graph showing the relationship between a transmission distance and a magnetic coupling coefficient kₘ between two coils (power supply coil and power receiving coil).

FIGS. 15A and 15B are graphs of an experimental result showing the relationship between the transmission distance and the transmission power between two coils (power supply coil and power receiving coil).

FIG. 16 is a graph showing an experimental result of the transmission power with respect to the rotation angle of two coils (power supply coil and power receiving coil).

FIGS. 17A to 17D are schematic perspective views and internal perspective views showing an example of applying the wireless power supply system according to the embodiments 1 to 3 of the present invention to a motor.

### MODES FOR CARRYING OUT THE INVENTION

The present invention relates to a wireless power supply system utilizing Parity-Time symmetry (hereinafter referred to as “PT symmetry”).

Hereinafter, the embodiments of the present invention will be explained in detail with reference to the drawings.

First, the wireless power supply technology will be explained. Several technologies are known for the wireless power supply such as an electromagnetic induction system and a magnetic field resonance system. Among these, an electromagnetic induction wireless power supply technology is used, for example, for charging mobile phones, where coils are arranged vertically. Namely, based on the same principle as a transformer, the electric power can be transmitted only when the distance (transmission distance) between the power supply coil and the power receiving coil is very close.

However, in the electromagnetic induction wireless power supply technology, the transmission distance is short (e.g., about several millimeters). Thus, a large distance cannot be achieved between the power supply coil and the power receiving coil. In addition, if the positions of the power supply coil and the power receiving coil are misaligned or separated even slightly, neither charging nor power supply is possible (i.e., vulnerable to positional displacement). Therefore, it is difficult to apply to artificial devices installed inside the human body such as an artificial heart or devices with multi-directional rotation or axis misalignment such as a robot arm.

In the magnetic field resonance wireless power supply technology, the transmission distance is long (e.g., several centimeters to several meters). The distance between the power supply coil and the power receiving coil can be larger compared to the electromagnetic induction system. Thus, the magnetic field resonance wireless power supply technology is at a level close to practical application. However, the electric power cannot be transmitted unless the distance between the power supply coil and the power receiving coil is kept constant and fixed. If the distance becomes closer or farther or if the angles are different, the transmission efficiency decreases and necessary power cannot be transmitted. Thus, the magnetic field resonance wireless power supply technology is sensitive. Namely, the magnetic field resonance wireless power supply technology is also vulnerable to the positional displacement and difficult to apply to devices (rotating power supply target) with multi-directional rotation or axis misalignment such as a robot arm.

Patent Document 1 discloses a wireless power supply system that includes a control device having functions for adjusting the positional relationship and the angle between a power supply coil and a power receiving coil in a magnetic field resonance wireless power supply technology to supply an electric power stably to an auxiliary artificial heart or the like. According to the above described configuration, even if the positions shift up and down by several centimeters due to human body movement, the control device adjusts by changing parameters each time to match the positional displacement.

However, the above described system requires functions to adjust the distance between the power supply coil and the power receiving coil to be constant and to adjust the angle to be constant. This causes problems that the control device (external device such as power transmission device) becomes large-scale, and advanced control such as adjusting the positional relationship and the angle between the coils must be continuously performed. Thus, a load is applied to a control unit of the control device (external device such as power transmission device). In addition, there is a problem that the advanced control function stops during battery replacement when supplying the electric power to the external device.

Therefore, there is a strong demand for a wireless power supply system that requires no adjustment or control of the positions and the angles of the power supply coil and the power receiving coil for rotating the power supply target and can continuously supply the electric power wirelessly without interruption regardless of how much the power receiving coil rotates relative to the power supply coil. Various wireless power supply methods have been repeatedly tested and verified, but none have been found that can withstand practical use.

Here, as one wireless power supply method, there is a technology called wireless power supply utilizing Parity-Time symmetry (hereinafter referred to as “PT symmetry”). In the wireless power supply system utilizing the PT symmetry, even if the transmission distance changes or the positional displacement occurs between the power supply coil and the power receiving coil, the transmission power is always kept constant if the PT symmetry is preserved. Namely, the wireless power supply system utilizing the PT symmetry replaces the AC power source in the conventional magnetic field resonance wireless power supply technology with an inverter that behaves electrically similarly to a negative resistor (i.e., inverter that behaves as a negative resistor).

The above described system is known technology as disclosed, for example, in Patent Document 3. To explain in more detail, an inverter that behaves as a negative resistor is an inverter whose switching frequency and voltage amplitude are not fixed in advance, and has a circuit configuration where the switching frequency is determined by the apparent resonance frequency of the wireless power supply circuit as seen from the output terminal of the inverter. The inverter follows changes in the apparent resonance frequency of the wireless power supply circuit, which can change due to changes in coil transmission distance or positional displacement, with fast response speed. Here, the wireless power supply circuit refers to a circuit including the power transmission side resonance circuit, the power receiving side resonance circuit, and all subsequent connected circuits. The apparent resonance frequency means the substantial resonance frequency considering the interaction between the power transmission side resonance circuit and the power receiving side resonance circuit.

However, the conventional wireless power supply system utilizing the PT symmetry operates at high frequencies of about 1-3 MHz. Since air-core coils are used as the power supply coil and the power receiving coil, a large coil dimension is required and an applicable application is limited. Specifically, the coil dimension in the conventional wireless power supply system utilizing the PT symmetry is about 60 cm in diameter (shown in Non-Patent Document 1). In addition, since the frequency is high, when a metallic object (conductive object) is placed around the power supply coil and the power receiving coil, the transmission efficiency decreases due to eddy current loss generated in the conductive object. Therefore, it is impossible to apply the above described technology to the rotating power supply target.

One of the applicants of the present invention invented a wireless power supply device utilizing the PT symmetry that can maintain high transmission efficiency even when the transmission distance changes or the coil positional displacement occurs and can reduce the transmission efficiency degradation even when a metallic object is placed nearby by using low frequencies of 100 kHz or below while enabling miniaturization of the power supply coil and the power receiving coil for adoption in various applications, and an application is filed in 2021 (shown in Patent Document 3).

The present invention further evolves the technology in the wireless power supply device utilizing the PT symmetry of the prior Patent Document 3. The present invention is arrived at through repeated experiments and trial and error to make it applicable to the wireless power supply even when the positions and the angle of the power supply coil and the power receiving coil shift or separate more.

In the embodiments of the present invention, a rotating robot arm will be explained as an example of the power supply target. However, the present invention is not limited to the rotating power supply target. In addition, the coil shape is not limited to the solenoid-type coil.

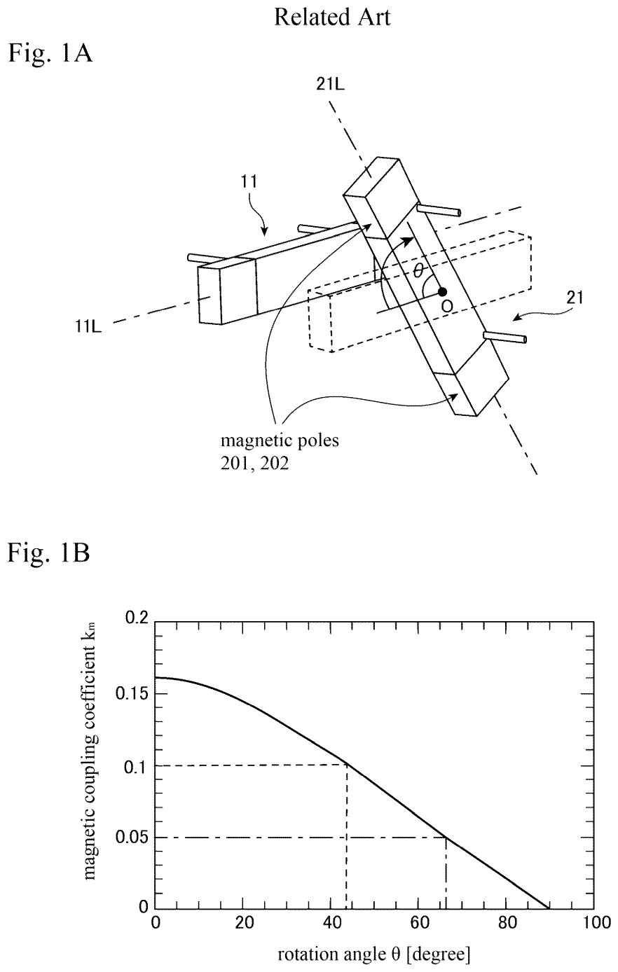

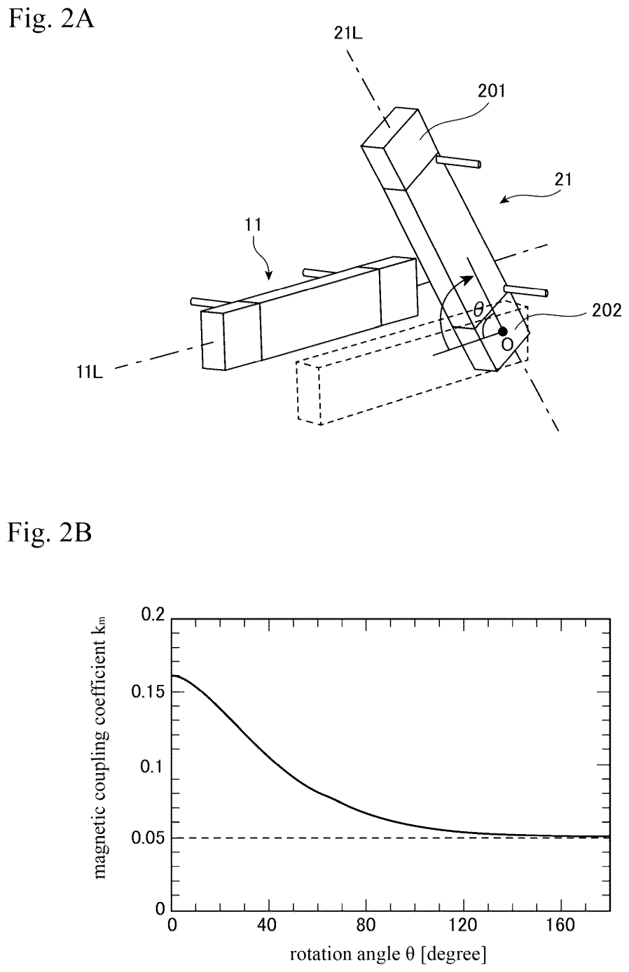

FIGS. 1A and 1B are drawings showing the positional relationship between coils and the relationship between a rotation angle θ and a magnetic coupling coefficient kₘ when a rotation center O is at a central part of a power receiving coil in a rotating power supply target in a wireless power supply system utilizing the PT symmetry. In the conventional robot arm, as shown in FIG. 1A, the rotation center O of a power receiving coil 21 is generally near the center of a power receiving coil 21. Here, the state where the axis line 11L of the power supply coil 11 and the axis line 21L of the power receiving coil 21 shown by dashed-dotted lines in FIG. 1A are parallel is defined as the rotation angle 0 degrees, and the angle between the two axis lines is defined as the rotation angle θ (the same applies to FIG. 2A described later).

The dashed line in FIG. 1A shows the power receiving coil before rotation. Before the rotation, the axis line 11L of the power supply coil 11 and the axis line of the power receiving coil are parallel (the power receiving coil with the dashed line has no reference numeral and no axis line in the drawing). The power receiving coil 21 shown by the solid line is the power receiving coil after rotating by the rotation angle θ around the center near the central part of the power receiving coil.

In the coil arrangement shown in FIG. 1A (i.e., when the rotation center O is near the central part of the power receiving coil 21), it can be seen that the magnetic coupling coefficient Kₘ becomes 0 (zero) at a certain angle of the rotation angle θ between the power supply coil 11 and the power receiving coil 21 (here, rotation angle 90 degrees) (shown in FIG. 1B). When the magnetic coupling coefficient kₘ becomes 0 (zero), the power supply becomes impossible even with the wireless power supply using the PT symmetry. Therefore, the robot arm capable of 360-degree rotation cannot be continuously powered and operated. To achieve complex movements, it is necessary to use a multi-joint robot arm that operates within ranges where the magnetic coupling coefficient kₘ does not become 0 (zero). Namely, the multi-joint robot arm that operates within ranges that do not reach plus or minus 90 degrees should be used in this case.

FIGS. 2A and 2B show the first example of the coil arrangement such that the magnetic coupling coefficient kₘ does not become 0 (zero) at any rotation angle θ. FIGS. 2A and 2B are drawings showing the positional relationship between coils and the relationship between the rotation angle θ and the magnetic coupling coefficient kₘ when the rotation center O is at one of two magnetic poles provided at both ends of a solenoid-type power receiving coil in the rotating power supply target in the wireless power supply system utilizing the PT symmetry in the embodiment 1 of the present invention.

Similar to FIG. 1A, the dashed line in FIG. 2A shows the power receiving coil before rotation. Before the rotation, the axis line 11L of the power supply coil 11 and the axis line of the power receiving coil are parallel (the power receiving coil with the dashed line has no reference numeral and no axis line in the drawing). The power receiving coil 21 shown by the solid line is the power receiving coil after rotating by the rotation angle θ around near one of the two magnetic poles provided at both ends of the power receiving coil 21 (in the example shown in FIG. 2A, magnetic pole 202).

Namely, FIG. 2A shows the positional relationship of the coils when the rotation center O is located at one of two magnetic poles (201, 202) provided at both ends of the power receiving coil 21, and FIG. 2B shows the relationship between the rotation angle θ and the magnetic coupling coefficient kₘ in the positional relationship of the coils in FIG. 2A. Here, although the manner of change slightly differs due to differences in the coil shape and the rotation center position, the tendency for the magnetic coupling coefficient kₘ to decrease as the rotation angle θ increases is common to both in FIGS. 1A and 1B and FIGS. 2A and 2B. However, in the case of the positional relationship of the coils shown in FIG. 2A (i.e., when the rotation center O is near one of the two magnetic poles (201, 202) provided at both ends of the power receiving coil 21), the rotation angle where the magnetic coupling coefficient kₘ becomes 0 (zero) can be eliminated as shown in FIG. 2B. In this state, the transmission power can be made constant at any rotation angle θ by utilizing the PT symmetry.

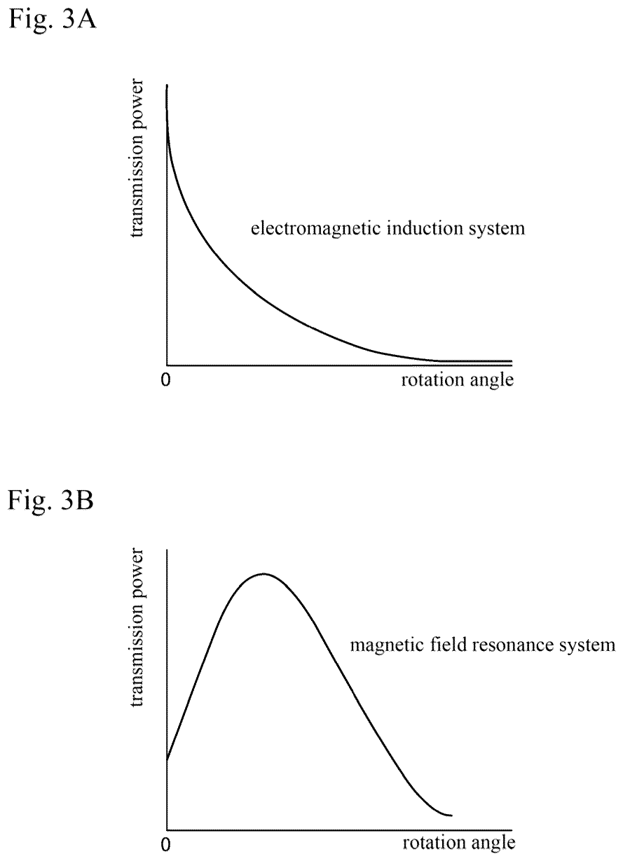

Here, repeating the explanation, existing wireless power supply technologies are explained. The wireless power supply using the magnetic field includes an electromagnetic induction system and a magnetic field resonance system. FIGS. 3A and 3B are graphs showing a relationship between the rotation angle and the transmission power of two coils (power supply coil and power receiving coil) used in the wireless power supply system. FIG. 3A shows the case of the electromagnetic induction system, and FIG. 3B shows the case of the magnetic field resonance system.

In the electromagnetic induction system, as the magnetic coupling coefficient kₘ decreases, the transmittable power (transmission power) also decreases. Therefore, the relationship between the rotation angle of the two coils and the transmission power is, as shown in the graph of FIG. 3A, where the transmission power is largest when the rotation angle is 0 (zero) and the transmission power decreases as the rotation angle increases.

In the magnetic field resonance system, the power supply circuit and the power receiving circuit resonate at a specific magnetic coupling coefficient kₘ value to create a strong coupling state. Thus, the transmission power is maximized at the specific magnetic coupling coefficient kₘ value. Therefore, the relationship between the rotation angle of the two coils and the transmission power is, as shown in the graph of FIG. 3B, where the transmission power is largest at a specific rotation angle and the transmission power decreases as the deviation from the specific rotation angle increases.

As described above, the transmission power changes when the rotation angle changes in both systems commonly. In applications, a load (device) attached to the power receiving side needs constant power supply. Thus, it is undesirable for the transmission power to change with the rotation angle. Therefore, power control must be performed by some method to make the transmission power constant.

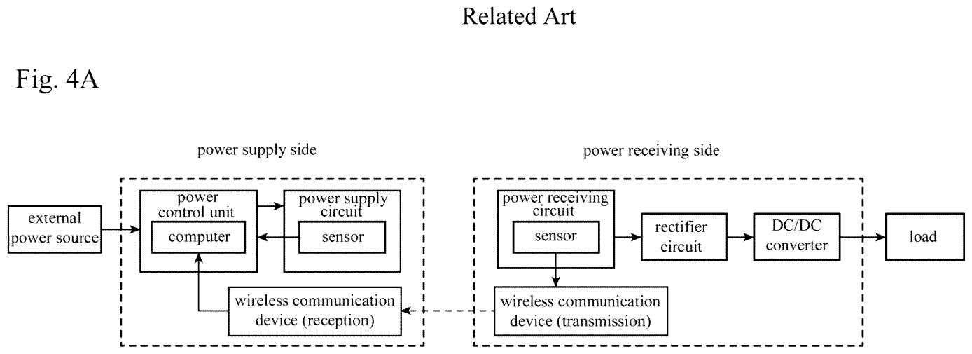

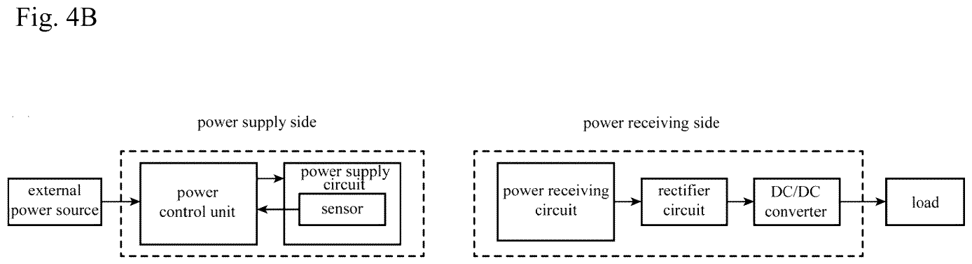

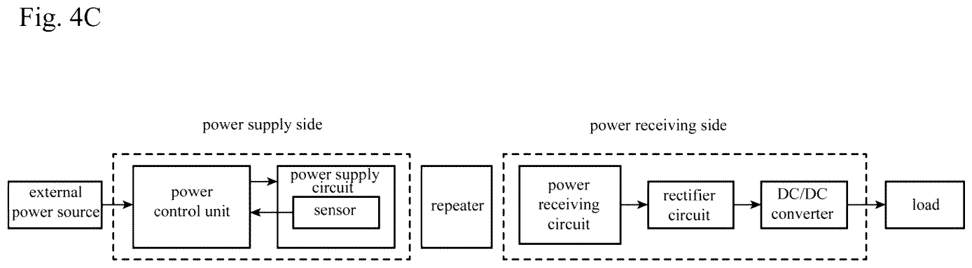

Here, the system configuration of the wireless power supply system will be explained. FIGS. 4A to 4C are explanatory drawings showing an example of a schematic configuration of the wireless power supply system. FIG. 4A shows a typical system configuration for performing the power control in existing technology. FIG. 4B shows an example of the system configuration when utilizing the PT symmetry (without repeater). FIG. 4C shows another example of the system configuration when utilizing the PT symmetry (with repeater).

When performing the power control with the existing method, the system configuration shown in FIG. 4A can be considered. The above described system configuration requires sensors for detecting a voltage value and a current value in the power supply circuit and the power receiving circuit, a wireless communication device for feeding back the detected values from the power receiving side to a power control unit on the power supply side and a computer for performing arithmetic processing of the detected values in the power control unit. However, when the angular velocity of the rotation is high, the power control cannot follow the speed of the rotation. Thus, it is predicted that the power control is difficult with the above described configuration.

The factor that reduces the power control response speed includes a temporal delay generated in the above described wireless communication device and computer. If the power control were performed without using the communication device and the computer, the response speed could be improved. Therefore, the present invention utilizes the physical law called PT symmetry. As mentioned earlier, when the PT symmetry is utilized, the condition where the transmission power is not affected by the magnetic coupling coefficient kₘ can be created as a physical phenomenon. Therefore, even when the rotation angle changes, the transmission power remains constant and the objective can be achieved. With the above described method, since the above described communication device and computer are not needed, the power control can be achieved with high response speed using the system configuration shown in FIG. 4B in the case without repeater.

As described in Non-Patent Document 2, the PT symmetry can be preserved even when a relay coil is placed between the power supply coil in the power supply circuit and the power receiving coil in the power receiving circuit. Actually, a capacitor is connected to the relay coil to form a resonance circuit. When the above described resonance circuit is called a repeater, the system configuration including the repeater shown in FIG. 4C is also considered. The above described configuration is assumed when applying the wireless power supply utilizing the PT symmetry to a multi-joint robot arm as described later. The condition for the resonator is that the natural resonance frequency of the repeater matches the natural resonance frequencies of the power supply circuit and the power receiving circuit. Here, the natural resonance frequency means the resonance frequency of an individual resonator.

Next, the limit value (critical angle) of the rotation angle will be explained. As a condition for preserving the PT symmetry, there is a critical magnetic coupling coefficient k_{mc} that shows the limit value (critical value) of the magnetic coupling coefficient kₘ As mentioned earlier, when the PT symmetry is preserved, the transmission power remains constant even when the magnetic coupling coefficient kₘ changes (even when the positions and the angle of two coils change). However, when the magnetic coupling coefficient kₘ falls below the value of the critical magnetic coupling coefficient k_{mc}, the PT symmetry cannot be preserved and it becomes difficult to keep the transmission power constant. In an actual system, when the magnetic coupling coefficient kₘ falls below the value of the critical magnetic coupling coefficient k_{mc}, the transmission power decreases significantly and the wireless power supply becomes practically difficult.

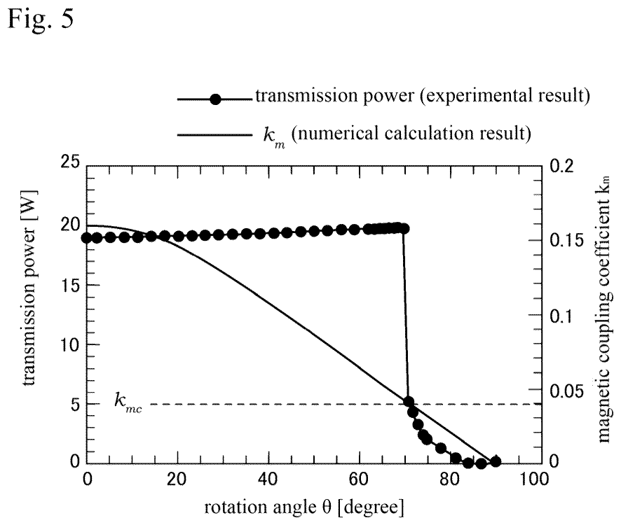

FIG. 5 is a graph of the experimental result showing a relationship between a magnetic coupling coefficient kₘ, a critical magnetic coupling coefficient k_{mc} and a transmission power when rotating around the central part of the power receiving coil shown in FIG. 1A. Namely, FIG. 5 is a graph showing the relationship between the transmission power and the magnetic coupling coefficient with respect to the rotation angle of two coils (power supply coil and power receiving coil) shown in FIG. 1A. The horizontal axis shows the rotation angle and the vertical axis shows the transmission power and the magnetic coupling coefficient.

In the example of FIG. 5, as shown by the dashed line in the graph, the critical magnetic coupling coefficient k_{mc} is 0.039. The critical magnetic coupling coefficient k_{mc} is a unique value and constant for the individual system. On the other hand, the magnetic coupling coefficient kₘ is a variable. The magnetic coupling coefficient kₘ tends to decrease as the rotation angle θ of the two coils increases. The black circles in the graph show the experimental result of the transmission power and the solid line shows the numerical calculation result of the magnetic coupling coefficient kₘ.

In the example shown in FIG. 5, the magnetic coupling coefficient kₘ matches the critical magnetic coupling coefficient k_{mc} around 70 degrees of the rotation angle θ between the two coils. In this case, the PT symmetry is preserved up to the rotation angle 70 degrees where the magnetic coupling coefficient kₘ takes values larger than the critical magnetic coupling coefficient k_{mc}. Thus, the transmission power is maintained at an approximately constant value (about 18 W in this example). After that, when the rotation angle θ exceeds 70 degrees, the magnetic coupling coefficient kₘ takes values smaller than the critical magnetic coupling coefficient k_{mc}. Thus, the PT symmetry cannot be preserved and the transmission power decreases significantly.

In applications, it is desirable to make the critical angle as large as possible. If the PT symmetry can be preserved at any rotation angle, the transmission power will remain constant even when the power receiving coil is rotated through a full 360 degrees. This enables the wireless power supply to a continuously rotating power-receiving target.

Next, the method for increasing the critical angle will be explained using the graphs showing the relationship between the rotation angle θ and the magnetic coupling coefficient kₘ shown in FIG. 1B and FIG. 2B. As shown by the dashed line in FIG. 1B, when the arrangement of the two coils is as in FIG. 1A, if the critical magnetic coupling coefficient k_{mc} is 0.1, the PT symmetry can be preserved up to the rotation angle 44 degrees. Namely, the critical angle when the critical magnetic coupling coefficient k_{mc} is 0.1 is 44 degrees. Since the graph is symmetrical for the negative rotation angle, the PT symmetry is actually preserved in the range of +44 degrees (total 88 degrees).

As shown by the dashed-dotted line in FIG. 1B, if the critical magnetic coupling coefficient k_{mc} is 0.05, the PT symmetry is preserved up to +66 degrees (total 132 degrees). Therefore, to increase the critical angle, the critical magnetic coupling coefficient k_{mc}, which has an inverse relationship with the critical angle, should be reduced.

The method for reducing the critical magnetic coupling coefficient k_{mc} will be described later, but one method for increasing the critical angle is to keep the magnetic coupling coefficient kₘ as large as possible. This can be achieved through the coil arrangement. This is the coil arrangement shown in FIG. 2A. Please refer to FIG. 2B, which is a graph when the rotation center O is at one magnetic pole (201 or 202) of the power receiving coil 21.

In the case of the coil arrangement as shown in FIG. 2A, if the critical magnetic coupling coefficient k_{mc} is 0.05 (the line shown by the dashed line in FIG. 2B), the magnetic coupling coefficient kₘ does not fall below the critical magnetic coupling coefficient k_{mc} at any angle. Thus, it is possible to preserve the PT symmetry up to +180 degrees (total 360 degrees) and enable continuous rotation of the power receiving coil.

As described above, the critical angle can be increased by the arrangement (positional relationship) of the power supply coil 11 and the power receiving coil 21. Specifically, when the coil is arranged so that the rotation center O is at the central part of the power receiving coil 21 as shown in FIG. 1A, the critical angle becomes narrower. On the other hand, when the rotation center O is at one of the magnetic poles (201 or 202) of the power receiving coil 21 as shown in FIG. 2A, the critical angle becomes wider.

Namely, as shown in FIG. 2A, the power supply coil 11 and the power receiving coil 21 are arranged so that the rotation center O of the power receiving coil 21 comes near one of the two magnetic poles (201, 202) provided at both ends of the power receiving coil 21. Thus, the critical angle can be increased and the range of the rotation angle and the transmission distance where the PT symmetry can be preserved can be expanded. Thus, continuous wireless power supply is enabled while preserving the PT symmetry and keeping the transmission power constant when rotating the power receiving coil 21 relative to the power supply coil 11.

However, the wireless power supply is not limited to the rotating power supply target. Even for a non-rotating power supply target, in order to continuously perform the wireless power supply while preserving the PT symmetry and keeping the transmission power constant, it is necessary to make the critical magnetic coupling coefficient k_{mc} as small as possible so that the magnetic coupling coefficient kₘ does not fall below the critical magnetic coupling coefficient k_{mc}. Therefore, the present invention proposes the method for reducing the critical magnetic coupling coefficient k_{mc} in the wireless power supply system using the PT symmetry.

### Embodiment 1

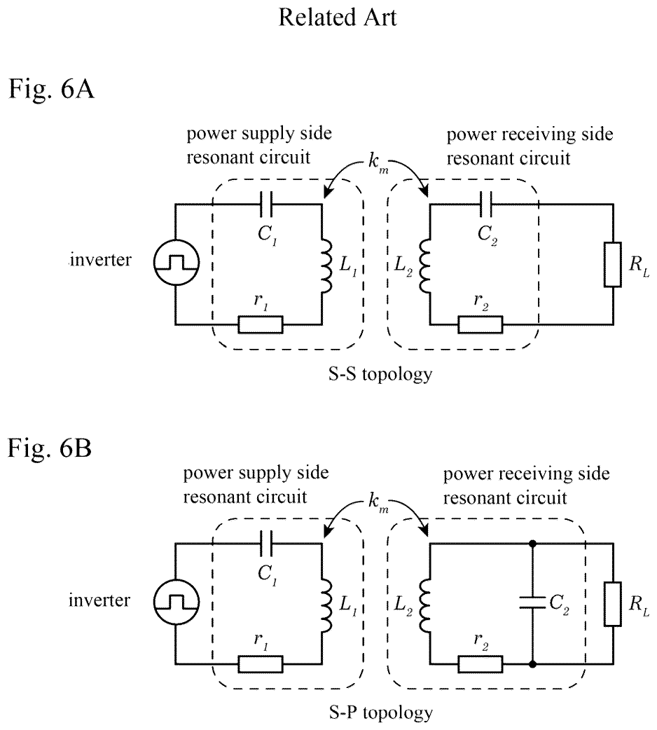

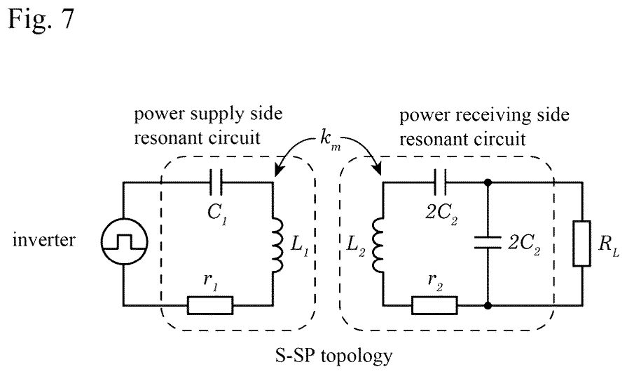

First, one method for reducing the critical magnetic coupling coefficient k_{mc} will be explained. FIGS. 6A and 6B are conceptual diagrams showing the circuit configuration of a conventional magnetic resonance wireless power supply system utilizing the PT symmetry. In addition, FIG. 7 is a conceptual diagram showing an example of the circuit configuration of a magnetic resonance wireless power supply system utilizing the PT symmetry according to the embodiment 1 of the present invention.

In all circuit examples shown in FIGS. 6A and 6B and FIG. 7, the power supply side resonator is connected to an inverter that functions as a power supply source. On the other hand, a load of a load resistance R_{L} is connected to the power receiving side resonant circuit. Namely, R_{L} is the load resistance of the wireless power supply system. In the above described circuit, L₁ represents the self-inductance of the power supply coil, C₁ represents the capacitance of the power supply side capacitor, L₂ represents the self-inductance of the power receiving coil, and C₂ represents the capacitance of the power receiving side capacitor. In addition, r₁ and r₂ represent resistance components included in the power supply side resonator and the power receiving side resonator respectively.

The circuit example shown in FIG. 6A is called S-S topology because the coil and the capacitor of the power supply side resonant circuit are connected in series, and the coil and capacitor of the power receiving side resonant circuit are also connected in series. The circuit example shown in FIG. 6B is called S-P topology since the coil and the capacitor of the power supply side resonant circuit are connected in series, and the coil and the capacitor of the power receiving side resonant circuit are connected in parallel. An example of the wireless power supply that preserves the PT symmetry in S-S topology is disclosed in Non-Patent Document 3, and an example of the wireless power supply that preserves the PT symmetry in S-P topology is disclosed in Non-Patent Document 4.

In the circuit example shown in FIG. 7, the power receiving side resonant circuit has a circuit configuration using two capacitors, and this circuit configuration of the power receiving side is the circuit configuration of the wireless power supply system in the present invention. The circuit configuration shown in FIG. 7 has a power receiving coil and two capacitors with capacitance 2C₂ connected in series and a load (rectifier circuit) is connected in parallel to both ends of one of the two capacitors in the configuration of the resonant circuit within the power receiving circuit. Thus, the above described circuit configuration is called S-SP topology.

Here, the capacitance of each capacitor is written as 2C₂ in FIG. 7. This means that the capacitance 2C₂ is twice the capacitance C₂ of the capacitor shown in the circuit examples in FIG. 6A and FIG. 6B. Actually, it is not necessary for the capacitance to be exactly twice. However, if the capacitance is 2C₂, the resonant frequency f₂ of the power receiving side resonant circuit in FIGS. 6A, 6B and FIG. 7 is all equal and can be expressed as Equation (1). Thus, it is possible to compare the three topologies shown in FIGS. 6A, 6B and FIG. 7 on an equal basis. Therefore, the capacitance is expressed this way.

$$\begin{matrix}[ Equation 1 ] & \\ {f}_{2} = 1 / ( 2 π √ ( {L}_{2} {C}_{2} ) ) & ( 1 )\end{matrix}$$

Next, it will be explained that the critical magnetic coupling coefficient k_{mc} in S-SP topology shown in FIG. 7 can be a smaller value compared to S-P topology shown in FIG. 6B. The formulas for the critical magnetic coupling coefficient k_{mc} in each topology shown in FIG. 6A, 6B and FIG. 7 can be derived as the following Equations (2) to (4). Namely, the critical magnetic coupling coefficient k_{mc} of the S-S topology shown in FIG. 6A is expressed by the following Equation (2).

$$\begin{matrix}[ Equation 2 ] & \\ {k}_{mc} = ( 1 / {Q}_{2} ) + ( {R}_{L} / {Z}_{0} ) & ( 2 )\end{matrix}$$

$$\begin{matrix}[ Equation 3 ] & \\ {k}_{mc} = ( 1 / {Q}_{2} ) + ( {Z}_{0} / {R}_{L} ) & ( 3 )\end{matrix}$$

$$\begin{matrix}[ Equation 4 ] & \\ {k}_{mc} = ( 1 / {Q}_{2} ) + ( {Z}_{0} / 4 {R}_{L} ) & ( 4 )\end{matrix}$$

Here, Z₀ is called the characteristic impedance of the power receiving side resonant circuit. The above described characteristic impedance Z₀ of the power receiving side resonant circuit can be expressed by the following Equation (5).

$$\begin{matrix}[ Equation 5 ] & \\ {Z}_{0} = √ ( {L}_{2} / {C}_{2} ) & ( 5 )\end{matrix}$$

In addition, Q₂ is the quality factor of the power receiving side resonant circuit. The above described quality factor Q₂ of the power receiving side resonant circuit can be expressed by the following Equation (6).

$$\begin{matrix}[ Equation 6 ] & \\ {Q}_{2} = 2 π {f}_{2} {L}_{2} / {r}_{2} & ( 6 )\end{matrix}$$

In actual systems, in all topologies (i.e., in Equations (2), (3) and (4) above), since the first term (1/Q₂) can be set to a sufficiently smaller value than the second term, the second term is the dominant term in determining the critical magnetic coupling coefficient k_{mc}.

Comparing the second terms of S-P topology (Equation (3)) and S-SP topology (Equation (4)), it can be seen that the second term of S-SP topology is one-fourth of the second term of S-P topology. Therefore, by using S-SP topology, the value of the critical magnetic coupling coefficient k_{mc} can be reduced to about one-fourth compared to S-P topology. Thus, the allowable range of the coil rotation angle can be expanded.

In FIG. 7, the capacitances of two capacitors are set to 2C₂. However, the effect of reducing the critical magnetic coupling coefficient k_{mc} can be expected even without making them the same value. The condition for the capacitances of two capacitors is to satisfy the following Equation (7) when the combined capacitance of two capacitors is C₂₀.

$$\begin{matrix}[ Equation 7 ] & \\ {C}_{20} = {L}_{1} {C}_{1} / {L}_{2} & ( 7 )\end{matrix}$$

As described above, by using the circuit configuration of S-SP topology as shown in FIG. 7 (i.e., the circuit configuration where a power receiving coil and two capacitors are connected in series and a rectifier circuit is connected to both ends of one of the two capacitors in the configuration of the resonant circuit within the power receiving circuit), the value of the critical magnetic coupling coefficient k_{mc} that can preserve the PT symmetry can be reduced, and the range of the rotation angle and the transmission distance where PT symmetry can be preserved can be further expanded. Thus, it is possible to continuously perform the wireless power supply while preserving the PT symmetry and keeping the transmission power constant when rotating the power receiving coil relative to the power supply coil.

This means that the diodes are reverse-biased and the diodes have capacitance in the rectifier circuit. However, the capacitance has nonlinear characteristics with respect to reverse bias voltage. Thus, the capacitance changes with respect to the voltage. As a result, when the rectifier circuit is connected, the resonant frequency also changes. Consequently, the output voltage of the power receiving side resonant circuit can be stabilized. However, with the circuit configuration of S-SP topology as shown in FIG. 7, it can be assumed that the capacitance component of the rectifier circuit does not affect the resonant frequency of the power receiving side resonant circuit.

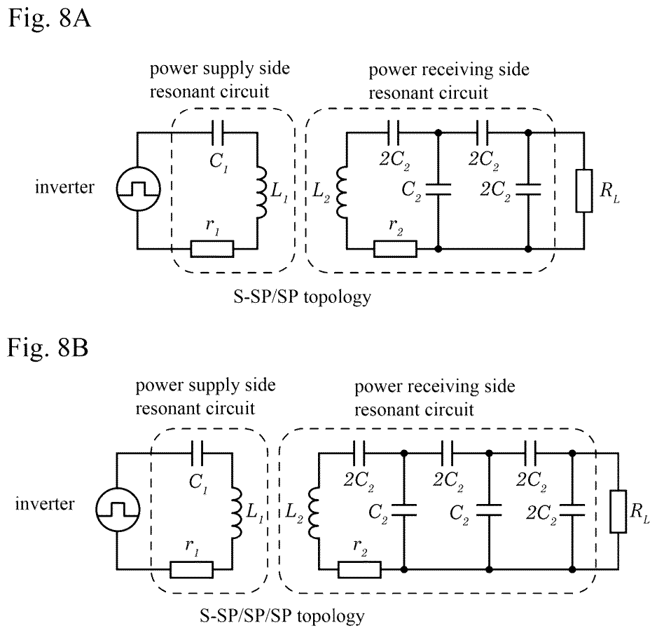

FIGS. 8A and 8B are conceptual diagrams showing another example of the circuit configuration of the magnetic resonance wireless power supply system utilizing the PT symmetry according to the embodiment 1 of the present invention. Namely, FIGS. 8A and 8B are modifications of S-SP topology of FIG. 7. FIG. 8A shows S-SP/SP topology and FIG. 8B shows S-SP/SP/SP topology. These also have the circuit configuration where the power receiving coil and two capacitors are directly connected and the rectifier circuit is connected to both ends of one of the two capacitors in the configuration of the resonant circuit within the power receiving circuit.

First, the critical magnetic coupling coefficient k_{mc} can be smaller also in S-SP/SP topology as shown in FIG. 8A compared to S-P topology shown in FIG. 6B. The formula for the critical magnetic coupling coefficient k_{mc} in the case of S-SP/SP topology in FIG. 8A is the following Equation (8).

$$\begin{matrix}[ Equation 8 ] & \\ {k}_{mc} = ( 1 / {Q}_{2} ) + ( {Z}_{0} / 16 {R}_{L} ) & ( 8 )\end{matrix}$$

As described above, compared to S-P topology shown in FIG. 6B, the critical magnetic coupling coefficient k_{mc} can be reduced to about one-sixteenth in S-SP/SP topology shown in FIG. 8A. Thus, the allowable range of the coil rotation angle can be expanded. Note that the effect of reducing the critical magnetic coupling coefficient k_{mc} can still be expected even if the capacitances of the four capacitors are not as shown in FIG. 8A. In addition, the condition for the capacitances of the capacitors is to satisfy the following Equation (9) when the combined capacitance of the four capacitors as seen from both ends of the power receiving coil (L₂) is C40.

$$\begin{matrix}[ Equation 9 ] & \\ {C}_{40} = {L}_{1} {C}_{1} / {L}_{2} & ( 9 )\end{matrix}$$

In addition, as a circuit that further modifies FIG. 8A, the effect of reducing the critical magnetic coupling coefficient k_{mc} can also be expected in S-SP/SP/SP topology shown in FIG. 8B. S-SP/SP topology shown in FIG. 8A is a two-stage ladder circuit, while S-SP/SP/SP topology shown in FIG. 8B is a three-stage ladder circuit. In principle, it is possible to make the ladder circuit n stages. In that case, the condition for the capacitances of the capacitors is to satisfy the following Equation (10) when the combined capacitance of 2n capacitors as seen from both ends of the power receiving coil (L₂) is C₂ₙ₀.

$$\begin{matrix}[ Equation 10 ] & \\ {C}_{2 n 0} = {L}_{1} {C}_{1} / {L}_{2} & ( 10 )\end{matrix}$$

As described above, when using the circuit configurations shown in FIG. 7 or FIGS. 8A, 8B (i.e., the power receiving coil and two capacitors are connected in series and the rectifier circuit is connected to both ends of one of the two capacitors in the configuration of the resonant circuit within the power receiving circuit utilizing the PT symmetry wireless power supply), the value of the critical magnetic coupling coefficient k_{mc} that can preserve PT symmetry can be reduced, and the range of the rotation angle and the transmission distance where the PT symmetry can be preserved can be expanded. Thus, it is possible to continuously supply the electric power wirelessly while preserving the PT symmetry and keeping the transmission power constant without requiring the adjustment or control of the positions and the angle of the power supply coil and the power receiving coil, with simple structure, and with high transmission efficiency maintained without interruption even if the positions and the angle of the power supply coil and the power receiving coil shift or separate slightly with more tolerance than conventional systems regarding the positional relationship between the two coils.

When the wireless power supply load is a simple pure resistance for heating purposes, AC drive is possible and the rectification is unnecessary. Therefore, when the load is pure resistance, instead of connecting the rectifier circuit to both ends of one capacitor, it is also possible that a pure resistance is directly connected to both ends of one capacitor as a load.

### Embodiment 2

Similar to the embodiment 1 above, another method for reducing the critical magnetic coupling coefficient k_{mc} will be explained. As can be seen from the second terms of the above described Equation (3) and Equation (4), it can be said that the critical magnetic coupling coefficient k_{mc} can be made small if the value of load resistance R_{L} is large in S-P topology and S-SP topology. However, in actual applications, the value of the load resistance cannot be freely chosen. For example, for a load of 10V voltage and 20 W power, the load resistance R_{L} is determined to be 5 ohms. Therefore, it is difficult to adjust the load resistance to a convenient value.

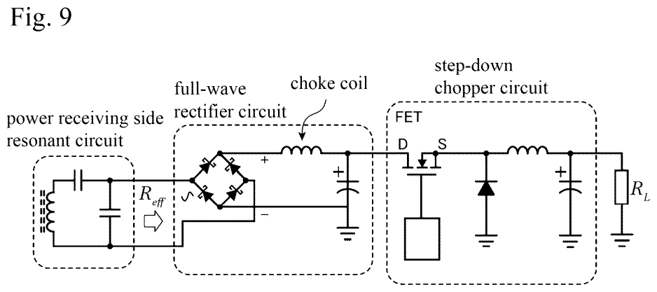

As a method to solve the above described problem, the circuit configuration of the power receiving circuit shown in FIG. 9 is proposed. FIG. 9 is a circuit configuration diagram showing an example of the power receiving circuit in the magnetic resonance wireless power supply system utilizing the PT symmetry according to the embodiment 2 of the present invention. In the circuit example shown in FIG. 9, the rectifier circuit is connected downstream of the power receiving side resonator of S-SP topology, a step-down converter (a type of DC/DC converter where the output voltage is lower than the input voltage is called a “step-down converter”) is connected, and a load is connected. If there were no rectifier circuit or step-down converter, the critical magnetic coupling coefficient k_{mc} would follow the above described Equation (4). However, when the rectifier circuit and the step-down converter are connected, Equation (4) can be rewritten as the following Equation (11).

$$\begin{matrix}[ Equation 11 ] & \\ {k}_{mc} = ( 1 / {Q}_{2} ) + ( {Z}_{0} / 4 {R}_{eff} ) & ( 11 )\end{matrix}$$

Here, R_{eff} is called AC equivalent load resistance. Actually, the load resistance R_{L} is connected (to the DC circuit) through the rectifier circuit and the DC/DC converter. However, if the load resistance were connected directly to the AC circuit (power receiving side resonant circuit) without passing through the rectifier circuit and the DC/DC converter, the resistance value as seen from the power receiving side resonant circuit that would be equal (equivalent) in both cases is the AC equivalent load resistance R_{eff}. Namely, the AC equivalent load resistance R_{eff} is the equivalent resistance value connected to the power receiving side resonant circuit and is a different value from the load resistance R_{L}. How the value of the AC equivalent load resistance R_{eff} is determined will be explained next.

FIG. 9 more specifically shows the details of the power receiving circuit in the system configuration without the relay utilizing the PT symmetry shown in FIG. 4B where a full-wave rectifier circuit is used as the rectifier circuit and a step-down chopper circuit is used as the DC/DC converter.

As is well known, the step-down chopper circuits periodically turn ON/OFF the semiconductor switching devices such as FETs (the state where the drain-source is conducting is called ON, and the state where the drain-source is not conducting current is called OFF), thereby periodically creating states where the current flows and does not flow between drain-source. In one period, if the time when the current flows is T_{ON} and the time when the current does not flow is T_{OFF}, the duty ratio D representing the proportion of the time when the current flows can be expressed by the following Equation (12).

$$\begin{matrix}[ Equation 12 ] & \\ D = {T}_{ON} / ( {T}_{ON} + {T}_{OFF} ) & ( 12 )\end{matrix}$$

It is well known that the duty ratio D and the output voltage of the step-down chopper circuit are proportional, and it is also well known that the output voltage can be stably controlled by automatically adjusting (automatically controlling) the duty ratio D. In the present invention, the duty ratio D is also used for the purpose of reducing the critical magnetic coupling coefficient k_{mc}. The above described AC equivalent load resistance R_{eff} can be expressed as the following Equation (13).

$$\begin{matrix}[ Equation 13 ] & \\ {R}_{eff} = 0.62 {R}_{L} / {D}^{2} & ( 13 )\end{matrix}$$

The AC equivalent load resistance R_{eff} is proportional to the load resistance R_{L} divided by the square of the duty ratio D² due to the action of the step-down chopper circuit. Note that the coefficient 0.62 in the Equation (13) is not a universal value and may be a different value due to differences in the circuit configuration or the like. However, the coefficient can be specified in advance by a circuit simulator or the like. The above described coefficient is called the resistance conversion coefficient.

For example, when the duty ratio D is 0.25 and the load resistance R_{L} is 10 ohms, the AC equivalent load resistance R_{eff} becomes 100 ohms according to the Equation (13). Namely, the AC equivalent load resistance R_{eff} can be made about 10 times larger than the actual load resistance value of 10 ohms. When the AC equivalent load resistance R_{eff} becomes larger, it can be seen from the Equation (11) that the critical magnetic coupling coefficient k_{mc} becomes smaller.

Namely, a rectifier circuit is connected to the resonant circuit, a step-down chopper type DC/DC converter is provided downstream of the rectifier circuit, and the value of AC equivalent load resistance R_{eff} connected to the resonant circuit within the power receiving circuit is adjusted by the value of the duty ratio D of the DC/DC converter in the configuration of the resonant circuit within the power receiving circuit. By using the above described circuit configuration, the value of the critical magnetic coupling coefficient k_{mc} that can preserve the PT symmetry can be reduced, and the range of the rotation angle and the transmission distance where the PT symmetry can be preserved can be expanded. Therefore, it is possible to continuously perform the wireless power supply while preserving the PT symmetry and keeping the transmission power constant when rotating the power receiving coil relative to the power supply coil.

In the power receiving circuit shown in FIG. 9, it is necessary to provide a choke coil before the smoothing capacitor of the full-wave rectifier circuit. The role of the choke coil in a general rectifier circuit is to remove ripple superimposed on the output DC current. However, the role of the choke coil in the embodiment 2 of the present invention is completely different. The role will be explained below.

As described above, from the Equation (11), it can be seen that large AC equivalent load resistance R_{eff} is necessary to reduce the critical magnetic coupling coefficient k_{mc}. In addition, from the Equation (13), it can be seen that the resistance conversion coefficient should be made a large value to increase the AC equivalent load resistance R_{eff}. Conversely, if the above described value becomes small, the AC equivalent load resistance R_{eff} also becomes small. As a result, the critical magnetic coupling coefficient k_{mc} cannot be made small. The choke coil prevents the above described situation. The mechanism will be explained below using analysis results from a circuit simulator.

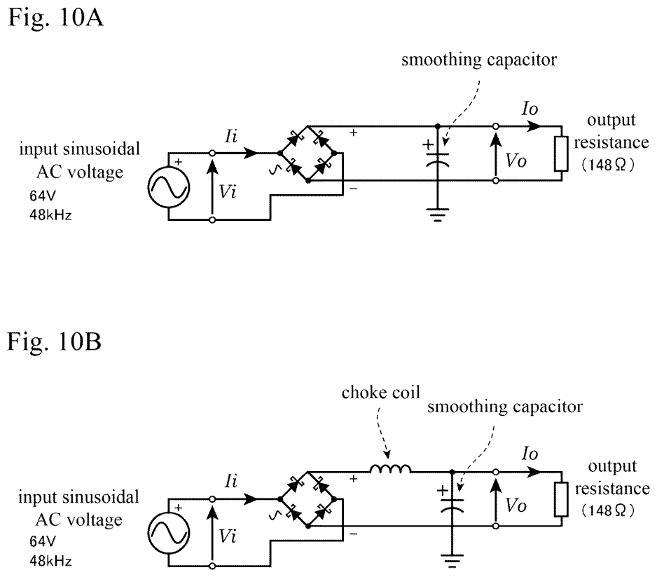

To make the explanation easier, only the full-wave rectifier circuit will be extracted for consideration. FIGS. 10A and 10B show simulation circuits for comparing and verifying the effect of the choke coil in the embodiment 2 of the present invention. FIG. 10A shows the circuit without a choke coil FIG. 10B shows the circuit with a choke coil.

The choke inductance is set to 18 pH same as the actual device. For input, a sinusoidal AC voltage Vi with the amplitude 64V and the frequency 48 KHz is input equivalent to the actual device. At the output terminal, 148 ohms is connected as a resistance component equivalent to the actual device. The above described resistance is called output resistance.

The input resistance as seen from the input terminal is the value of the input voltage Vi divided by the input current li. The above described input resistance corresponds to R_{eff}. If the input resistance is 59 ohms, since the output resistance is 148 ohms, the ratio is 0.40 (=59/148). The above described value corresponds to the resistance conversion coefficient in the Equation (13).

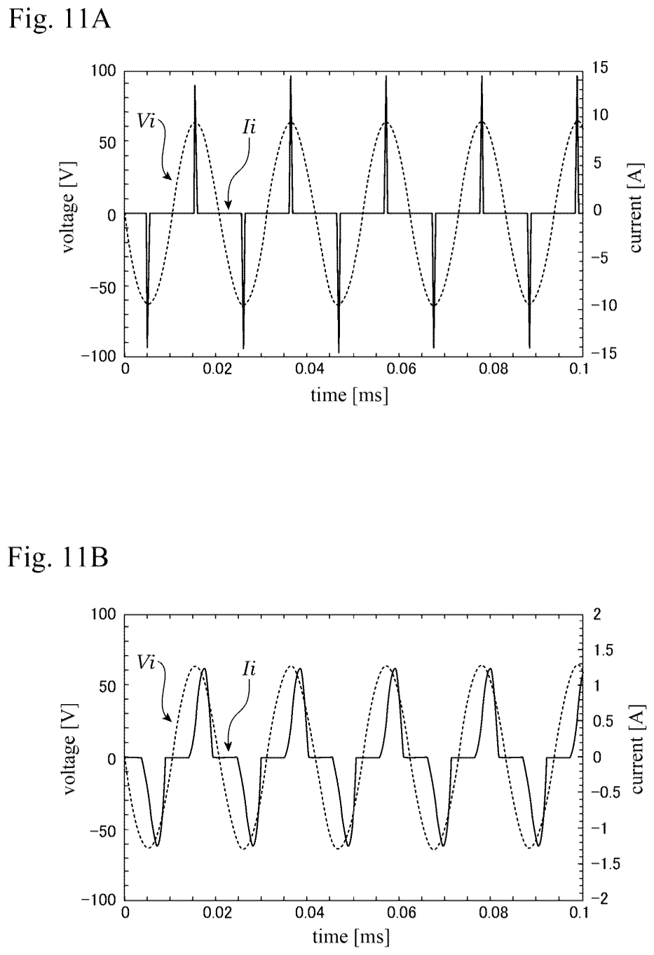

FIGS. 11A and 11B show the time-based changes (waveforms) of the input voltage Vi and the input current li for comparing and verifying the effect of the choke coil in the embodiment 2 of the present invention. FIG. 11A shows the waveforms without a choke coil. FIG. 11B shows the waveforms with a choke coil.

As can be seen from FIG. 11A, when there is no choke coil, the waveform of the input current li becomes a sharp spike-like waveform. This is caused by charging current rushing into the smoothing capacitor.

On the other hand, looking at the waveform of the circuit with a choke coil shown in FIG. 11B, the waveform of the input current li loses the sharpness compared to the case without a choke coil and changes to a smooth waveform. This is because the choke coil has the effect of suppressing inrush current.

Regardless of the presence or absence of the choke coil, when the input resistance is calculated by dividing the average value of the input voltage Vi and the average value of the input current li averaged over one period, both result in 182 ohms with no difference between them. However, the input resistance calculated from values averaged over one period cannot be called R_{eff}. The true input resistance R_{eff} is the input resistance value when energy is moving from the power receiving side resonant circuit toward the full-wave rectifier circuit. (Note that the input resistance R_{eff} is the input resistance value when calculating the critical magnetic coupling coefficient k_{mc} of the PT symmetry, and differs from the definition of the input resistance value in general circuit theory.)

As can be clearly seen from the input current li waveform in FIG. 11A, the time interval during which charging current flows into the smoothing capacitor is only a small interval within one period. During all other time intervals, the current flowing from the power receiving side resonant circuit toward the full-wave rectifier circuit is completely “zero”. This is because the input current li does not flow unless the input voltage Vi exceeds the charging voltage of the smoothing capacitor. Therefore, during time intervals when the input current li is not flowing, even if the input voltage Vi is a finite value, the energy is not moving from the power receiving side resonant circuit toward the full-wave rectifier circuit. Therefore, the true input resistance R_{eff} is the value obtained by dividing the average value of the input voltage Vi during the time interval when the current flows, as determined from the input current li waveform, by the average value of the input current li.

When there is no choke coil (case of FIG. 11A), since the input current li waveform becomes narrow and sharp, the current value also becomes large and the input resistance R_{eff} becomes small. In the above described simulation, the true input resistance R_{eff} is 17.5 ohms. Therefore, the resistance conversion coefficient is 0.12 (=17.5/148).

When there is a choke coil (case of FIG. 11B), since the input current li waveform becomes wide and smooth, the current value also becomes small and the input resistance R_{eff} becomes large. In the above described simulation, the true input resistance R_{eff} is 91.0 ohms. Therefore, the resistance conversion coefficient is 0.61 (=91.0/148).

From the above, the choke coil has the effect of increasing the resistance conversion coefficient. As a result, a small critical magnetic coupling coefficient k_{mc} could be achieved. Note that a simple circuit using one choke coil is shown for ease of explanation in this circuit example. However, the other circuit configurations could also be considered. Specifically, even the circuit that smooths the input current li waveform by adding diodes and compensation capacitors as proposed in Non-Patent Document 5 can be expected to have similar effects.

Namely, a rectifier circuit is connected to the resonant circuit and a choke coil is provided between the rectifier diode and smoothing capacitor in the rectifier circuit in the configuration of the resonant circuit within the power receiving circuit. By using the above described circuit configuration, the distortion in the current waveform flowing from the power receiving side resonant circuit to the rectifier circuit can be reduced, and the deterioration of the range of rotation angle and transmission distance where the PT symmetry can be preserved due to harmonic generation caused by current distortion can be prevented. Thus, it is possible to continuously perform the wireless power supply while preserving the PT symmetry and keeping the transmission power constant.

As described above, in the circuit configuration shown in FIG. 10B (i.e., the circuit configuration where the rectifier circuit is connected to the resonant circuit and a choke coil is provided between the rectifier diode and smoothing capacitor in the rectifier circuit in the configuration of the resonant circuit within the power receiving circuit utilizing the PT symmetry wireless power supply), the value of the critical magnetic coupling coefficient k_{mc} that can preserve the PT symmetry can be reduced, the distortion in the current waveform flowing from the power receiving side resonant circuit to the rectifier circuit can be reduced, and the deterioration of the range of the rotation angle and the transmission distance where the PT symmetry can be preserved due to harmonic generation caused by current distortion can be prevented. Thus, it is possible to continuously supply the electric power wirelessly while preserving the PT symmetry and keeping the transmission power constant without requiring the adjustment or control of the positions and the angle of the power supply coil and the power receiving coil, with simple structure, and with high transmission efficiency maintained without interruption even if the positions and the angle of the power supply coil and the power receiving coil shift or separate slightly with more tolerance than conventional systems regarding the positional relationship between the two coils.

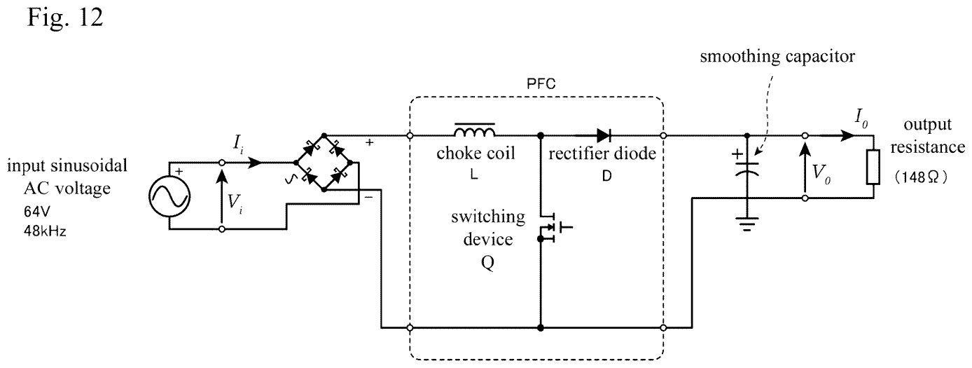

Here, the role of the choke coil in the embodiment 2 is to smooth the waveform of the input current li. The same effect can be obtained with a power factor correction circuit called a PFC circuit (Power Factor Correction circuit). The power factor 1 is when both voltage and current are sinusoidal waves, which is the most desirable state. Therefore, in the power receiving circuit shown in FIG. 12, the experiments were conducted to investigate the relationship with the critical magnetic coupling coefficient k_{mc} by adjusting the parameters of the choke coil and the PFC circuit.

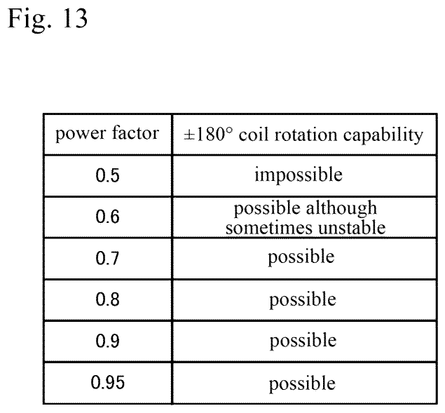

FIG. 12 is a circuit configuration diagram showing another example of a power receiving circuit in the magnetic resonance wireless power supply system utilizing the PT symmetry according to the embodiment 2 of the present invention. In addition, FIG. 13 is a table of the experimental result showing the relationship between the power factor and the coil rotation capability in the power receiving circuit shown in FIG. 12. As shown in FIG. 13, when the power factor is 0.5, there are angles where the electric power cannot be supplied when the coil is rotated 360 degrees (+180 degrees). When the power factor is 0.6, although sometimes unstable, the electric power can be supplied when the coil is rotated 360 degrees (+180 degrees). Furthermore, it goes without saying that it is better for the power factor to be close to 1.0. However, in the present experiment, when the power factor was 0.7, 0.8, 0.9, or 0.95, stable power could be supplied even when the coil is rotated 360 degrees (+180 degrees).

Namely, the results are obtained showing that if the power factor is adjusted to between 0.6 and 1.0, the efficiency of the transmission power in wireless power supply is sufficient. Thus, by using the power receiving circuit shown in FIG. 12 instead of the power receiving circuit shown in FIG. 10B, similar effects could be obtained.

As described above, in the circuit configurations as shown in FIG. 10B and FIG. 12 (i.e., the configuration where a rectifier circuit is connected to the resonant circuit, a power factor correction circuit such as a choke coil or PFC circuit is provided between the rectifier diode and smoothing capacitor in the rectifier circuit, and the power factor of the power factor correction circuit is adjusted to between 0.6 and 1.0 in the configuration of the resonant circuit within the power receiving circuit utilizing the PT symmetry wireless power supply), the value of critical magnetic coupling coefficient k_{mc} that can preserve the PT symmetry can be reduced, the distortion in the current waveform flowing from the power receiving side resonant circuit to the rectifier circuit can be reduced, and the deterioration of the range of rotation angle and transmission distance where the PT symmetry can be preserved due to harmonic generation caused by current distortion can be prevented. Thus, it is possible to continuously supply the electric power wirelessly while preserving the PT symmetry and keeping the transmission power constant without requiring the adjustment or control of the positions and the angle of the power supply coil and the power receiving coil, with simple structure, and with high transmission efficiency maintained without interruption even if the positions and the angle of the power supply coil and the power receiving coil shift or separate slightly with more tolerance than conventional systems regarding the positional relationship between the two coils.

### Embodiment 3

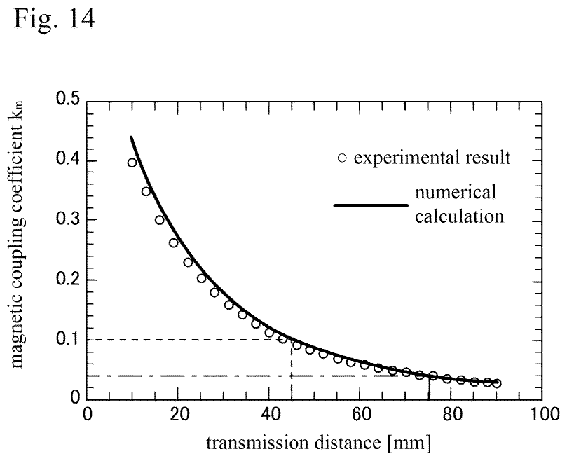

Similar to the above described embodiments 1 and 2, another method for reducing the critical magnetic coupling coefficient k_{mc} will be explained. Here, the results of experiments conducted using actual equipment with the system configuration without relay utilizing the PT symmetry shown in FIG. 4B to confirm whether it is possible to reduce the value of critical magnetic coupling coefficient k_{mc} using the duty ratio D of the step-down chopper circuit described above will be explained with reference to FIG. 14 to FIG. 17D.

First, the intent of the experiment will be explained. FIG. 14 is a graph showing the relationship between the transmission distance and the magnetic coupling coefficient kₘ between two coils (power supply coil and power receiving coil). The circles in FIG. 14 show the experimental result, and the solid line shows the numerical calculation result. However, it can be seen that the experimental result and the numerical calculation result are almost the same. Here, the transmission distance refers to the length of the gap between the power supply coil and the power receiving coil when the rotation angle of the two coils (power supply coil and power receiving coil) is 0 degrees. The magnetic coupling coefficient kₘ tends to decrease as the transmission distance increases.

According to FIG. 14, for example, if the critical magnetic coupling coefficient k_{mc} is 0.1, the critical transmission distance where the PT symmetry can be preserved is 45 mm (shown in broken line in FIG. 14). The above described critical distance is called the critical distance. If the critical magnetic coupling coefficient k_{mc} is 0.04, it can be easily read from the graph shown in FIG. 14 that the critical distance is 76 mm (shown as dashed line in FIG. 14). Namely, it can be seen that the smaller the critical magnetic coupling coefficient k_{mc}, the longer the critical distance becomes.

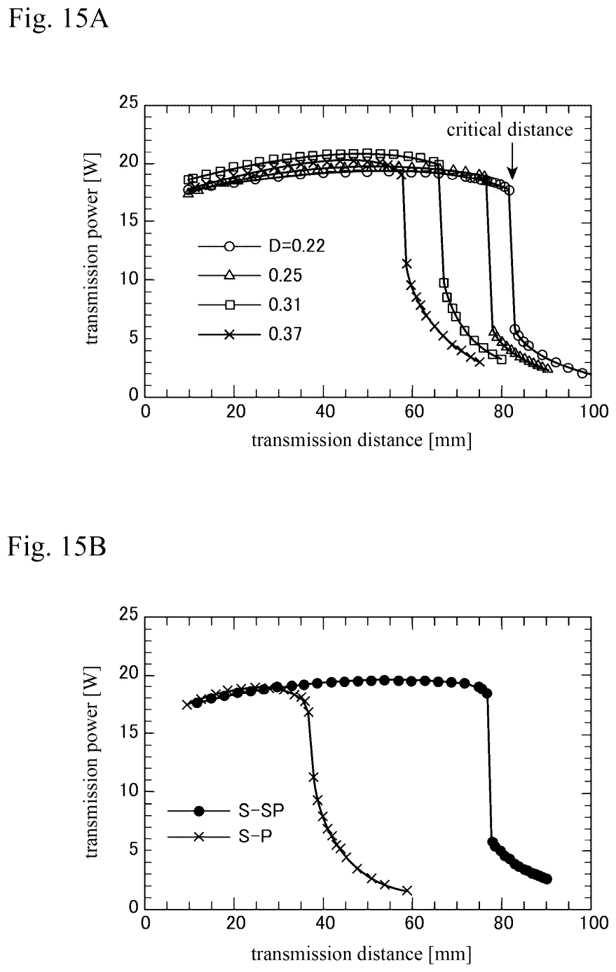

FIGS. 15A and 15B are graphs of the experimental result showing the relationship between the transmission distance and the transmission power between two coils (power supply coil and power receiving coil). FIG. 15A shows the experimental result investigating the relationship between the transmission distance and the transmission power of two coils (power supply coil and power receiving coil) under four conditions of the duty ratio D=0.22, 0.25, 0.31, 0.37. When the PT symmetry can no longer be maintained, the transmission power cannot be maintained constant and the transmission power drops sharply. The distance where the above described drop begins corresponds to the critical distance. Namely, it can be seen that the critical distance is 57 mm when the duty ratio D=0.37 (cross marks in FIG. 15A), the critical distance is 67 mm when the duty ratio D=0.31 (square marks in FIG. 15A), the critical distance is 77 mm when the duty ratio D=0.25 (triangle marks in FIG. 15A), and the critical distance is 84 mm when the duty ratio D=0.21 (circle marks in FIG. 15A).

As described above, according to the experimental result shown in FIG. 15A, it is confirmed that the critical distance extends by reducing the duty ratio D as intended. In addition, it was confirmed that the measured critical distance at each duty ratio D matches well with the calculated critical distance value calculated from the above described Equation (11) and the numerical calculation result of the transmission distance and the magnetic coupling coefficient kₘ shown in FIG. 14.

In addition, FIG. 15B shows the experimental result investigating the relationship between the transmission distance and the transmission power of two coils (power supply coil and power receiving coil) for S-P topology circuit (FIG. 6B) and S-SP topology circuit (FIG. 7). When the PT symmetry can no longer be maintained, the transmission power cannot be maintained constant and the transmission power drops sharply. The distance where the above described drop begins corresponds to the critical distance. Namely, S-P topology circuit (cross marks in FIG. 15B) has the critical distance of 37 mm, and S-P topology circuit (black circle marks in FIG. 15B has the critical distance of 77 mm.

As a result, it is confirmed that the critical magnetic coupling coefficient k_{mc} can be reduced to about one-fourth as shown in the Equations (3) and (4) by changing from S-P topology circuit (FIG. 6B) to S-SP topology circuit (FIG. 7). In addition, when the critical magnetic coupling coefficient k_{mc} becomes smaller, the critical angle can be widened. Since the critical magnetic coupling coefficient k_{mc} has the inverse relationship with the critical distance, by comparing the critical distances of S-P topology and S-SP topology, the difference in critical magnetic coupling coefficient k_{mc} can be confirmed indirectly.

The experimental result in FIG. 15B shows that the critical distance is significantly improved by changing from S-P topology to S-SP topology. Namely, the experiment means that the theoretically predicted effect is obtained by the improvement of S-SP topology described above and the improvement of the duty ratio D.

As described above, the step-down chopper circuit has the role of stabilizing the output voltage by automatically adjusting (automatically controlling) the duty ratio D. Thus, in the proposed system as well, the output voltage is stabilized by the automatic adjustment of the duty ratio D. However, if the duty ratio D changes during the operation, the critical magnetic coupling coefficient k_{mc} also changes and the critical angle and the critical distance fluctuate as well. This is undesirable since the PT symmetry is suddenly broken during the operation and the transmission power decreases dramatically.

As the method to solve the above described problem, the method of providing the upper limit value for the duty ratio D is proposed. For example, if the upper limit value of the duty ratio D is set to 0.3 in the step-down chopper circuit, and the output voltage control is performed with the duty ratio D in the range of 0 to 0.3, the upper limit value of the critical magnetic coupling coefficient k_{mc} is determined. Thus, the critical angle or the critical distance does not become smaller than the assumed value.

As the final confirmation that the above described logic is correct, the experiments were conducted to determine whether the transmission power can be kept constant even when the coil is rotated ±180 degrees (total 360 degrees) using the method proposed in the present invention. As described above, using the actual equipment with the system configuration without a relay utilizing the PT symmetry shown in FIG. 4B, the power receiving side resonant circuit was set to S-SP topology, the duty ratio D of the step-down chopper circuit was set to 0.26, and the load resistance R_{L} was set to 10 ohms. At this time, the value of the critical magnetic coupling coefficient k_{mc} calculated from the Equation (11) was 0.039.

Furthermore, the coil arrangement was set with one magnetic pole of the power receiving coil as the rotation center as shown in FIG. 2A. At this time, the transmission distance was fixed at 30 mm. Under the above described conditions, theoretically, the magnetic coupling coefficient kₘ does not fall below the critical magnetic coupling coefficient k_{mc} (=0.039) at any angle. Thus, it is predicted that the objective can be achieved.

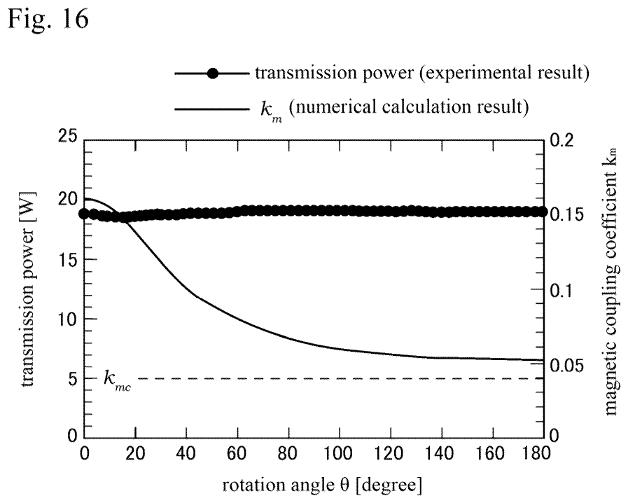

Here, FIG. 16 is the graph showing the experimental result of the transmission power with respect to the rotation angle of two coils (power supply coil and power receiving coil). FIG. 16 is the graph of the experimental result showing the relationship between the magnetic coupling coefficient kₘ, the critical magnetic coupling coefficient k_{mc}, and the transmission power with respect to the rotation angle when rotating around one of the two magnetic poles at both ends of the power receiving coil as shown in FIG. 2A.

Namely, FIG. 16 is the graph showing the relationship between the transmission power and the magnetic coupling coefficient with respect to the rotation angle of the two coils (power supply coil and power receiving coil) shown in FIG. 2A. The horizontal axis shows the rotation angle and the vertical axis shows the transmission power and the magnetic coupling coefficient. The broken line in the graph shows the critical magnetic coupling coefficient k_{mc} (=0.039), the black circles show the experimental result of the transmission power, and the solid line shows the numerical calculation result of the magnetic coupling coefficient. Note that FIG. 16 shows the experimental result when all of the embodiments 1, 2 and 3 are implemented.

As shown in FIG. 16, it is confirmed from the experimental result that the transmission power is maintained approximately constant over ±180 degrees (total 360 degrees). In addition, it is confirmed that the magnetic coupling coefficient kₘ does not fall below the critical magnetic coupling coefficient k_{mc} (=0.039) at any rotation angle, and the transmission power constancy is achieved as a result of the PT symmetry being preserved over 360 degrees. Furthermore, it is confirmed that the transmission power constancy is maintained even when the coils are continuously rotated for more than one full turn.

As described above, it is confirmed that the present invention is effective and has great merit not only through logical consideration but also through experiments.

As described above, the rectifier circuit is connected to the resonant circuit, the step-down chopper type DC/DC converter is provided downstream of the rectifier circuit, and the value of the AC equivalent load resistance connected to the resonant circuit within the power receiving circuit is adjusted by the value of the duty ratio D of the DC/DC converter in the configuration of the resonant circuit within the power receiving circuit. By using the circuit configuration, the value of the critical magnetic coupling coefficient k_{mc} that can preserve the PT symmetry can be reduced. Thus, it is possible to continuously supply the electric power wirelessly while preserving the PT symmetry and keeping the transmission power constant without requiring the adjustment or control of the positions and the angle of the power supply coil and the power receiving coil, with simple structure, and with high transmission efficiency maintained without interruption even if the positions and the angle of the power supply coil and the power receiving coil shift or separate slightly with more tolerance than conventional systems regarding the positional relationship between the two coils.

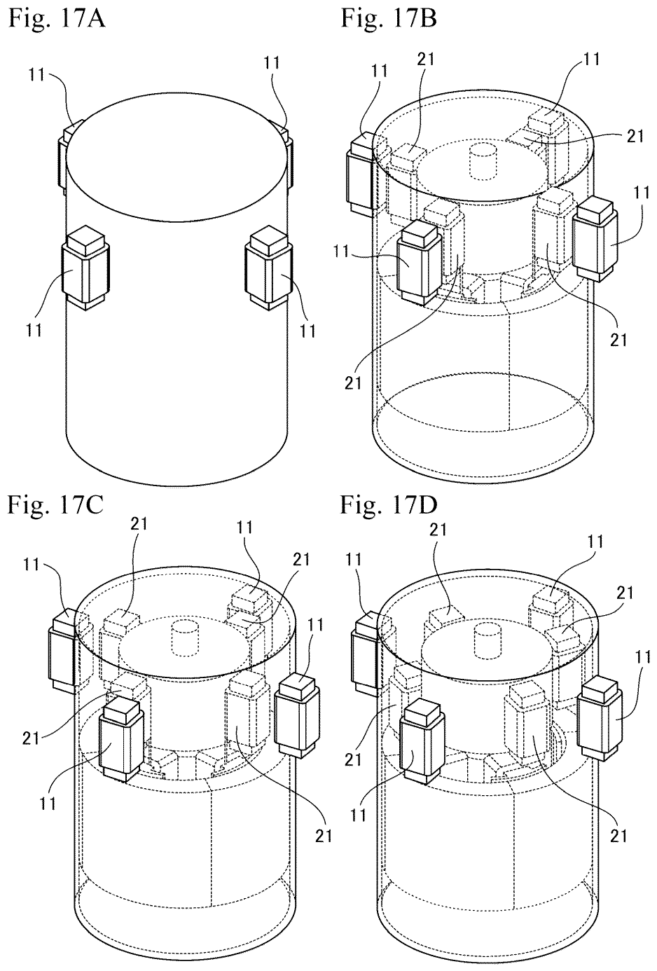

In addition, FIGS. 17A to 17D are schematic perspective views and internal perspective views showing an example of applying the wireless power supply system according to the embodiments 1-3 of the present invention to a motor. FIG. 17A is a perspective view looking down at the motor from diagonally above. FIG. 17B is an internal perspective view made transparent to show the inside of FIG. 17A. The upper part (upper half) of the motor shown in FIGS. 17A and 17B is the wireless power supply part, the lower part (lower half) is the motor, and the outer coil visible in FIG. 17A is the power supply coil 11. Note that FIG. 17B shows the state before rotation.

In addition, as shown in FIG. 17B, the coil (power receiving coil 21) is also arranged inside the wireless power supply part, and the inner power receiving coil 21 rotates with the motor rotation. Thus, the position varies (shown in FIGS. 17C and 17D). FIG. 17C shows a state where the motor has rotated slightly, and the power receiving coil 21, which is the inner coil, is rotated slightly and shifted relative to the power supply coil 11, which is the outer coil. In addition, FIG. 17D shows a state where the motor is rotated further than in FIG. 17C, and the power receiving coil 21, which is the inner coil, is rotated and shifted further relative to the power supply coil 11, which is the outer coil.

As described above, in the motor shown in FIGS. 17A to 17D, the power receiving coil 21 rotates with the motor rotation. Thus, the distance between the power supply coil 11 and the power receiving coil 21 approaches and separates and the positional relationship between the two coils is constantly fluctuating. However, even in a such case, by using the wireless power supply system utilizing the PT symmetry with the characteristics shown in the embodiments 1-3 of the present invention, the electric power supplied from the outer power supply coil 11 can be kept constant.

Note that free combinations of each embodiment, modifications of arbitrary components of each embodiment, and omission of arbitrary components in each embodiment are allowed in the present invention within the scope of the present invention.

### INDUSTRIAL APPLICABILITY

The wireless power supply system of the present invention can be applied to various devices that require the wireless power supply such as artificial organs and factory equipment. The present invention can also be applied to various power supply targets involving rotation such as robot arms and motors.

### DESCRIPTION OF SYMBOLS

11: power supply coil
11L: axis line of power supply coil 11
21: power receiving coil
21L: axis line of power receiving coil 21
201, 202: magnetic pole

1. A wireless power supply system utilizing Parity-Time symmetry, the wireless power supply system comprising:
a power supply circuit provided with a power supply coil; and
a power receiving circuit provided with a power receiving coil, wherein
each of the power supply circuit and the power receiving circuit includes a resonant circuit, and
in the resonant circuit of the power receiving circuit, the power receiving coil and two capacitors are connected in series and a rectifier circuit is connected to both ends of one of the two capacitors for continuously performing a wireless power supply while preserving the PT symmetry and keeping a transmission power constant.

2. A wireless power supply system utilizing Parity-Time symmetry, the wireless power supply system comprising:
a power supply circuit provided with a power supply coil; and
a power receiving circuit provided with a power receiving coil, wherein
each of the power supply circuit and the power receiving circuit includes a resonant circuit, and
in the resonant circuit of the power receiving circuit, a rectifier circuit is connected to the resonant circuit, a power factor correction circuit is provided between a rectifier diode and a smoothing capacitor in the rectifier circuit, and a power factor of the power factor correction circuit is adjusted to between 0.6 and 1.0 for continuously performing a wireless power supply while preserving the PT symmetry and keeping a transmission power constant.

3. A wireless power supply system utilizing Parity-Time symmetry, the wireless power supply system comprising:
a power supply circuit provided with a power supply coil; and
a power receiving circuit provided with a power receiving coil, wherein
each of the power supply circuit and the power receiving circuit includes a resonant circuit, and
in the resonant circuit of the power receiving circuit, a rectifier circuit is connected to the resonant circuit, a step-down chopper type DC/DC converter is provided downstream of the rectifier circuit, and a value of AC equivalent load resistance connected to the resonant circuit of the power receiving circuit is adjusted by a value of a duty ratio D of the DC/DC converter for continuously performing a wireless power supply while preserving the PT symmetry and keeping a transmission power constant.
